(19) United States
(12) Patent Application Publication
(10) Pub. No.: US 2016/0219169 A1
(43) Pub. Date: Jul. 28, 2016

(54) Control Device and Printing Device

(71) Applicant: Seiko Epson Corporation, Tokyo (JP)

(72) Inventor: Kazuma Sato, Shiojiri-Shi (JP)

(21) Appl. No.: 15/000,318

(22) Filed: Jan. 19, 2016

(30) Foreign Application Priority Data
Jan. 27, 2015 (JP) 2015-013032

(51) Int. Cl. H04N 1/00; G06F 3/0484

(52) U.S. Cl. CPC H04N 1/00411; H04N 1/00204; G06F 3/0484; H04N 2201/0094

(57) ABSTRACT

Provided is a control device for a printing device, the printing device including: a printing section configured to perform printing based on print data; and a receiving section configured to receive the print data over a network. The control device is configured to receive a character input for an input area displayed by a display section and, if the character does not comply with a validation rule applied to the input area, cause the input area to shake in the display section.

### BACKGROUND

1. Technical Field

The present invention relates to a control device for controlling a printing device and a printing device including the control device.

2. Related Art

Printing devices designed to perform printing on a medium such as a sheet of paper are known. Some of such printing devices have a display section that displays various kinds of information about the device and an operation section through which a user gives instructions to the device or changes the settings on the device. An example is disclosed in JP-A-2011-143627.

When a user wants to change settings on a printing device configured as described above, the user may have to input characters into an input field displayed by the display section. In this case, if the operation section allows input of not only characters valid for the input field but also characters not valid for the input field, the user may accidentally input an invalid character into the input field.

An example is as follows. In the case where the input field is for an IP address, the characters valid for the input field are numbers and the symbol “.”. However, if the operation section allows input of numbers, letters, and symbols, the user may accidentally input an invalid character such as a letter or a symbol other than “.” into the input field.

Furthermore, if the user is unaware of the invalid character and continues to input subsequent characters into the input field, the settings may be made on the basis of incorrect information or the entire process may have to be re-started. This is not user-friendly.

The above problem arises not only when the display section and the operation section are included in the printing device. Substantially the same problem also arises when the display section and the operation section are included in a separately provided information terminal and various settings and the like on the printing device are made through the information terminal.

### SUMMARY

An advantage of some aspects of the invention is that a control device for a printing device, which can notify a user that an invalid character has been input for an input field displayed by a display section, and a printing device including the control device, are provided.

According to an aspect of the invention, there is provided a control device for a printing device, the printing device including: a printing section configured to perform printing based on print data; and a receiving section configured to receive the print data over a network. The control device is configured to receive a character input for an input area displayed by a display section and, if the character does not comply with a validation rule applied to the input area, cause the input area to shake in the display section.

According to this aspect of the invention, the input area shakes in the display section if the character input for the input area displayed by the display section does not comply with the validation rule applied to the input area. This makes it possible, when an invalid character is input for the input area displayed by the display section, to notify the user that the invalid character has been input.

It is preferable that the control device be configured to, if the character input for the input area does not comply with the validation rule, display, in the input area, a character string indicating that the character does not comply with the validation rule.

According to this aspect of the invention, it is not necessary to provide, in the display section, an area only for a character string (message) indicating that the input character does not comply with the validation rule, and it is possible to make good use of the limited space of the display section. Furthermore, it is possible to notify the user that a character that does not comply with the validation rule has been input.

It is preferable that the control device be configured to, if the character input for the input area does not comply with the validation rule, cause the input area to shake in the display section and thereafter display the character string in the input area.

If the character string indicating that the input character does not comply with the validation rule is displayed in the input area while the input area is shaking in the display section, it is difficult for the user to see the character string. In this respect, according to the above aspect of the invention, the character string indicating that the input character does not comply with the validation rule is displayed after the shaking of the input area has ended. This makes it easier for the user to see the character string.

It is preferable that the control device be configured to cause the display section to display a plurality of the input areas and apply respective validation rules to the plurality of input areas.

According to the above aspect of the invention, even in the case where there exists a plurality of input areas assigned different acceptable characters and where some of the characters that can be input through the operation section are valid for one input area but not valid for another input area, such characters are validated appropriately in each input area.

It is preferable that the control device be configured to receive the character input for the input area displayed by the display section which is included in an information terminal on the network.

According to this aspect of the invention, even in the case where a user makes various settings or the like on the printing device through the information terminal over the network at a distance from the printing device, the user is notified when the user inputs an invalid character for the input area displayed by the display section of the information terminal.

According to another aspect of the invention, there is provided a printing device including: any of the control devices described above; a printing section configured to perform printing based on print data; and a receiving section configured to receive the print data over a network.

According to this aspect of the invention, the printing device provides the advantages of the above-described control device.

It is preferable that the printing device further include: a reading section configured to read an image; and a sending section configured to send, to an information terminal on the network, image data read by the reading section.

According to this aspect of the invention, it is possible to send image data read by the reading section to the information terminal on the network. Furthermore, if a user inputs an invalid character while inputting information about the information terminal (the destination to which the image data is to be sent) into the input area through the operation section, the user is notified that the input character is not valid.

### BRIEF DESCRIPTION OF THE DRAWINGS

The invention will be described with reference to the accompanying drawings, wherein like numbers reference like elements.

FIG. 1 is a block diagram schematically showing a configuration of a printing system including a printing device.

FIG. 2 schematically illustrates one example of a settings screen displayed by a display section of the printing device.

FIG. 3 is a table showing characters acceptable in input fields on the settings screen.

FIG. 4 is a flowchart showing a routine that the control device performs to determine whether or not a character input for an input field is valid.

FIGS. 5A to 5C schematically illustrate a transition of the settings screen on the display section when an invalid character is input for a second input field.

FIG. 6 is a block diagram schematically showing a configuration of a printing system of a modified embodiment.

### DESCRIPTION OF EXEMPLARY EMBODIMENTS

The following describes one embodiment of a printing device with reference to the drawings. In the present embodiment, the printing device is a multifunction device that has a printing function, scanning function, copying function, and the like.

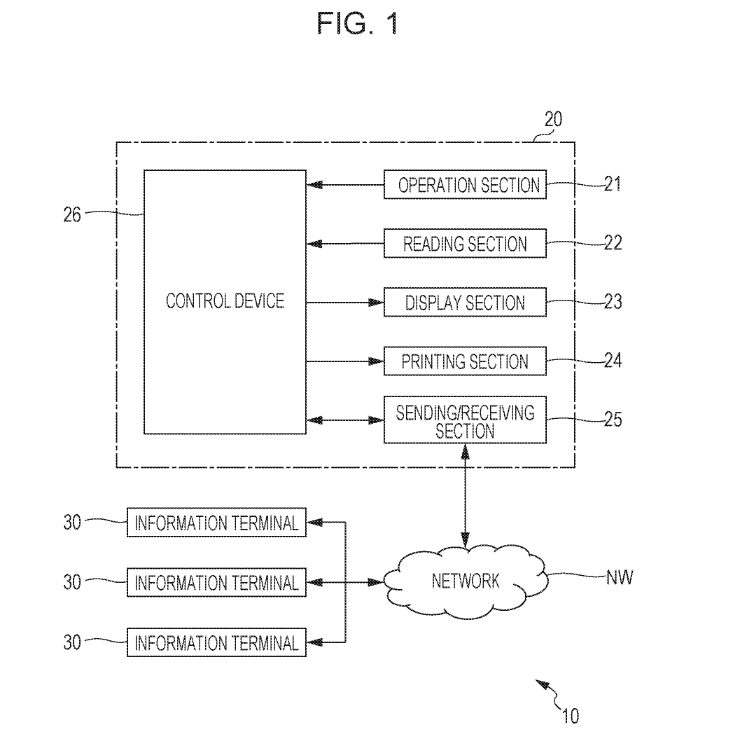

As illustrated in FIG. 1, a printing system 10 includes a printing device 20 and a plurality of information terminals 30 on a network NW.

The printing device 20 includes: an operation section 21 which is to be operated by a user; a reading section 22 which reads (scans) text and images formed on a medium; a display section 23 which displays various kinds of information about the printing device 20; a printing section 24 which performs printing on a medium; a sending/receiving section 25 which sends and receives information over the network NW; and a control device 26 which controls the device as a whole.

The operation section 21 instructs the printing device 20 to perform printing, scanning, or the like or makes various settings on the printing device 20 in response to a user operation. Therefore, the operation section 21 preferably allows input of characters such as numbers, letters, and symbols. The operation section 21 may be constituted by a touch screen displayed by, for example, a liquid crystal display, or may be constituted by physical keys.

It is preferable that the display section 23 be disposed on the printing device 20 near the operation section 21 in a way that the display section 23 is easily visible to the user. The display section 23 may be, for example, a liquid crystal display or the like.

The printing section 24 is configured to, for example, form text or images onto a medium such as a sheet of paper by ejecting ink onto the medium or by fixing toner onto the medium. In this respect, the printing device 20 of the present embodiment may be an ink jet printer, a laser printer, or another kind of printer.

The sending/receiving section 25 is a network interface via which information is exchanged between the printing device 20 and the information terminals 30 over the network NW. Via the sending/receiving section 25, the printing device 20 may establish either a wired or wireless connection with the network NW. In this respect, the sending/receiving section 25 serves as an example of both a “sending section” and a “receiving section”.

The control device 26 has: an input interface connected to the operation section 21, the reading section 22, and the sending/receiving section 25; and an output interface connected to the display section 23, the printing section 24, and the sending/receiving section 25. The control device 26 is configured to change the content displayed by the display section 23, cause the printing section 24 to perform printing based on print data received via the sending/receiving section 25, and cause the sending/receiving section 25 to send image data scanned by the reading section 22, in response to a user operation performed on the operation section 21.

The information terminals 30 are configured to send print data to the printing device 20 over the network NW and receive image data from the printing device 20 over the network NW. The information terminals 30 are, for example, personal computers or smartphones.

Various settings on the above-described printing device 20 are made through the operation section 21 and the display section 23. Specifically, a user of the printing device 20 makes various settings on the printing device 20 by inputting characters or selecting options through the operation section 21 while viewing a settings screen displayed by the display section 23.

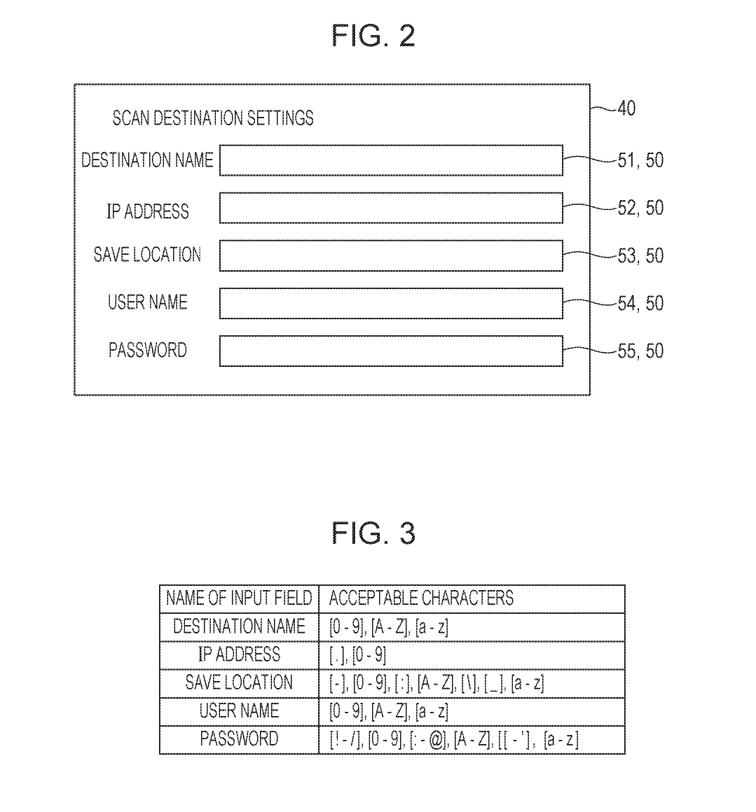

The following describes one example of the settings screen for the printing device 20 displayed by the display section 23 with reference to FIGS. 2 and 3. It should be noted that the settings screen for the printing device 20 in the present embodiment is for the settings of the reading section 22. Through this settings screen, the save location of scanned data is preregistered to the printing device 20.

Acceptable characters shown in FIG. 3 are so-called half-width characters arranged in the ASCII order. For example, “[0-9]” means all the numbers from “0 (zero)” to “9”.

As shown in FIG. 2, the settings screen 40 has a plurality of input fields 50, each of which is one example of an input area. The input fields 50 are used to specify the information terminal 30 connected to the printing device 20 over the network NW that is to receive a scanned image.

Specifically, the settings screen 40 has: a first input field 51 for the name of a destination of image data; a second input field 52 for the IP address of an information terminal 30 which is to receive the image data; and a third input field 53 for the save location of the image data in the information terminal 30. The settings screen 40 further has: a fourth input field 54 for the user name used to log in to the information terminal 30; and a fifth input field 55 for the password associated with the user name used to log in to the information terminal 30.

The destination name can be any name the user chooses. When scanning is performed, destination names are displayed by the display section 23 so that the user can select the destination for saving the scanned image. As shown in FIG. 3, the characters acceptable in the first input field 51 are numbers “0-9” and letters “A-Z” and “a-z”.

The second input field 52, which is for an IP address, is an input field 50 into which the IP address of the information terminal 30 is input. Therefore, as shown in FIG. 3, the characters acceptable in the second input field 52 are restricted to numbers “0-9” and the symbol “.”.

The save location is a folder (directory) to which the image data is to be saved. The save location is in the information terminal 30 specified by the IP address input in the second input field 52. As shown in FIG. 3, the characters acceptable in the third input field 53 are restricted to numbers “0-9”, letters “A-Z” and “a-z”, and symbols “-”, “_”, “:”, and “\”.

The user name is used to log in to the information terminal 30 specified by the IP address input in the second input field 52. In this respect, the above-described save location may be a user's private folder. As shown in FIG. 3, the characters acceptable in the fourth input field 54 are numbers “0-9” and letters “A-Z” and “a-z”.

The password is assigned to the user name which is used to log in to the information terminal 30 specified by the IP address input in the second input field 52. As shown in FIG. 3, the characters acceptable in the fifth input field 55 are numbers “0-9”, letters “A-Z” and “a-z”, and symbols “!-/”, “:-@”, and “[-`”.

It should be noted that the characters acceptable in each input field 50 are examples and may be changed appropriately depending on the environment of the printing device 20, operating system (OS) of the information terminal 30 connected to the printing device 20, and the like.

As has been described, each input field 50 is assigned acceptable characters. In the present embodiment, acceptable characters assigned to each of the plurality of input fields 50 serve as an example of a “validation rule”. In the following description, a character that can be input for the input fields 50 through the operation section 21 but is a character other than the acceptable characters shown in FIG. 3 may be referred to as a “prohibited character”.

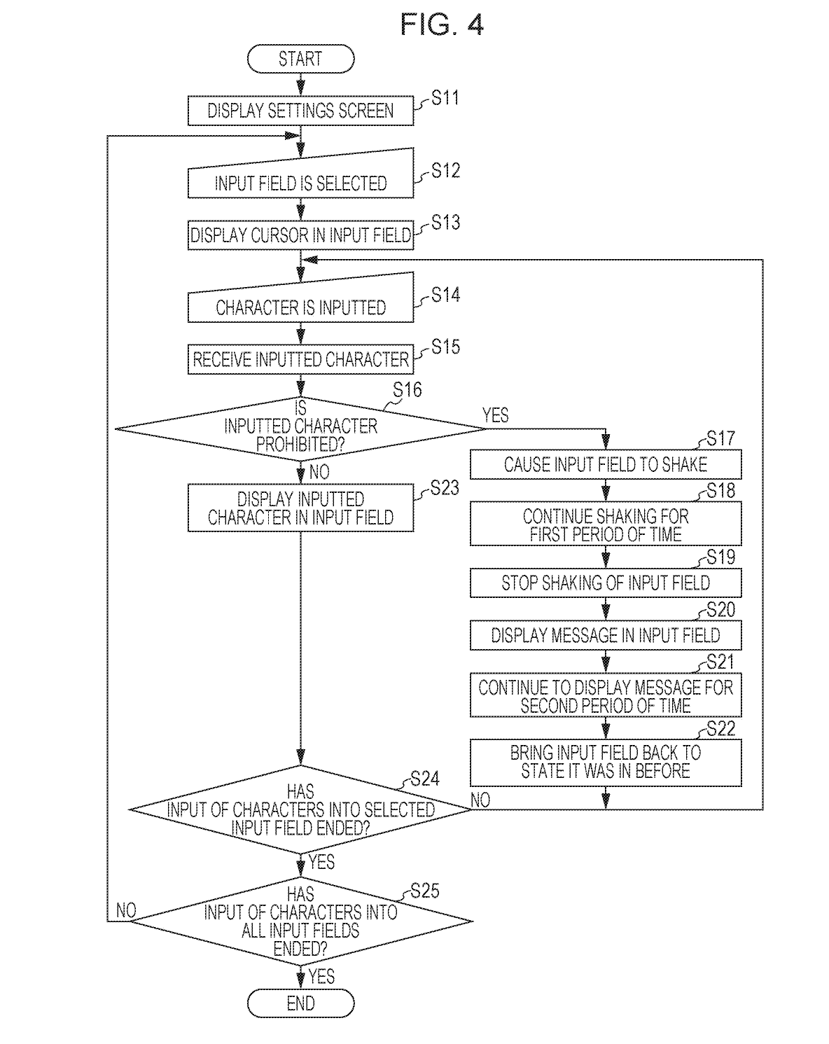

The following describes a routine that the control device 26 performs to determine whether or not a character input for an input field 50 is valid (i.e., whether or not the character is an acceptable character) with reference to the flowchart shown in FIG. 4. It should be noted that this routine is performed every time the settings screen 40 having the input fields 50 is displayed by the display section 23.

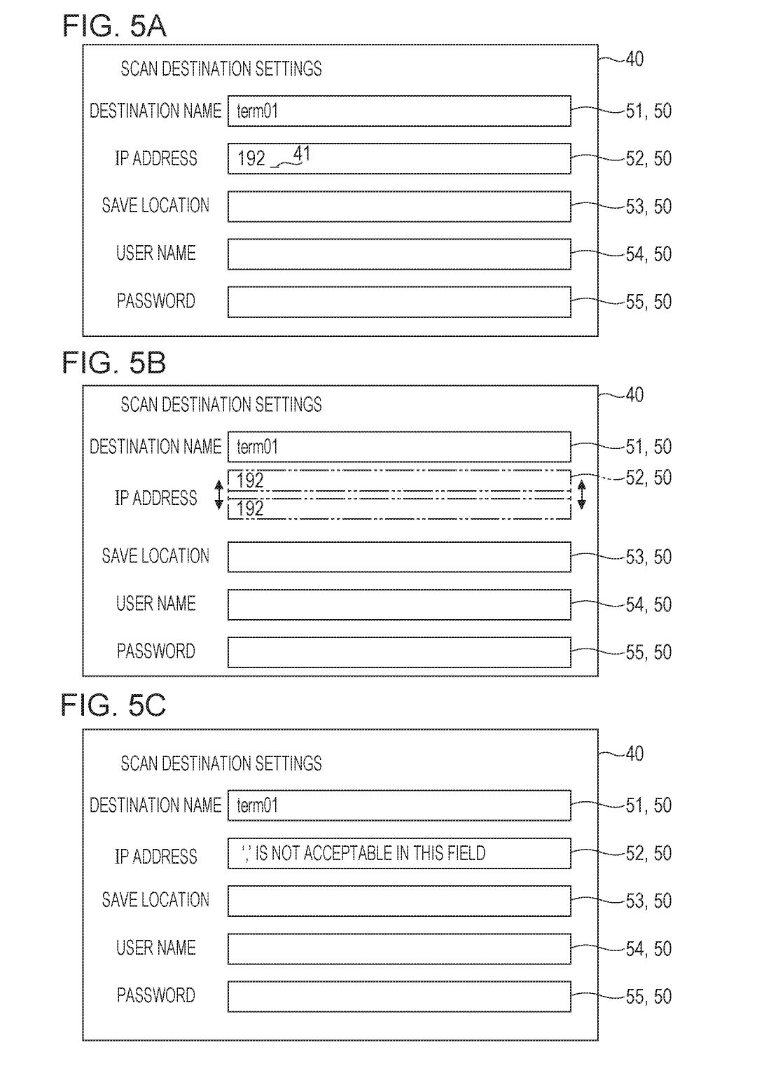

As shown in FIG. 4, the control device 26 causes the settings screen 40, which has a plurality of input fields 50 (refer to FIG. 2), to be displayed (step S11) and allows a user to select one of the input fields 50 (for example, the first input field 51) (step S12). Next, the control device 26 causes a cursor 41 (refer to FIG. 5A) to be displayed in the selected input field 50 (step S13) and allows the user to input characters into the input field 50 (step S14).

Next, the control device 26 receives the character input for the input field 50 (this character may be hereinafter referred to as an “input character”) (step S15). Next, the control device 26 determines whether or not the received input character is a prohibited character (step S16). Specifically, the control device 26 determines that the received input character is not a prohibited character if the input character is one of the acceptable characters assigned to the input field 50. On the other hand, if the input character is a character other than the acceptable characters assigned to the input field 50, the control device 26 determines that the input character is a prohibited character.

For example, in the case where the number “1” is input for the first input field 51, the control device 26 determines that the number “1” is not a prohibited character because the number “1” is one of the acceptable characters assigned to the first input field 51. On the other hand, in the case where the symbol “-” is input for the first input field 51, the control device 26 determines that the symbol “-” is a prohibited character because the symbol “-” is a character other than the acceptable characters assigned to the first input field 51.

In the case where the character input for the input field 50 is a prohibited character (YES in step S16), the control device 26 causes the input field 50, which is on the settings screen 40 displayed by the display section 23, to shake in the settings screen 40 (step S17) and continues shaking the input field 50 for a first period of time (step S18).

It should be noted here that the input field 50 may shake sideways or up and down or may shake like swinging about an axis perpendicular to the input field 50. Two or more of these ways of shaking may be combined. Further, note that the first period corresponds to a period from the start of the shaking of the input field 50 to the end of the shaking. The first period may be, for example, approximately 1 second.

Next, after the first period of time since the start of step S17, the control device 26 stops the shaking of the input field 50 (step S19) and causes a message, which indicates that the input character is an invalid character, to be displayed in the input field 50 (step S20). Next, the control device 26 continues to display the message in the input field 50 for a second period of time (step S21). It should be noted here that the second period corresponds to a period from the start of the display of the message in the input field 50 to the end of the display. The second period may be, for example, approximately 1 second.

Then, after the second period of time since the start of step S20, the control device 26 reverts the input field 50 to its previous state (step S22) and the process returns to step S14. This reverts the input field 50 to the state preceding message display, i.e., the state before the prohibited character was input.

On the other hand, in the case where it is determined that the character input for the input field 50 is not a prohibited character in step S16 (NO in step S16), the control device 26 causes the input character to be displayed in the input field 50 (step S23) and determines whether or not input of characters into the input field 50 has ended (step S24).

In the case where the input of characters into the input field 50 has not ended (NO in step S24), the process returns to step S14. On the other hand, in the case where the input of characters into the input field 50 has ended (YES in step S24), the control device 26 determines whether or not the input of characters into all the input fields 50 has ended (step S25). In the case where the input of characters into all the input fields 50 has not ended (NO in step S25), the process returns to step S12. On the other hand, in the case where the input of characters into all the input fields 50 has ended (YES in step S25), the control device 26 ends the process.

It should be noted that, in steps S24 and S25, the control device 26 may determine that the input of characters into an input field 50 has ended when, for example, the user has ended the input of characters into the input field 50 and placed the cursor in the next input field 50.

The following describes the functions of the printing device 20 of the present embodiment with reference to FIGS. 5A to 5C.

If a user wants to register a new destination of scanned image data to the printing device 20, a settings screen 40 shown in FIG. 5A is displayed by the display section 23. The user inputs necessary information (characters) into input fields 50 on the settings screen 40 displayed by the display section 23.

Specifically, the user selects the first input field 51 and inputs a destination name “term01” into the first input field 51. Next, the user selects the second input field 52 and inputs the IP address into the input field 52.

It should be noted that, in FIG. 5A, the user is currently inputting characters into the second input field 52. Therefore, a cursor 41 is displayed in the second input field 52. The cursor 41 indicates the position in the second input field 52 at which the input character will appear next.

Assume here that the symbol “,” is accidentally input instead of “.” after the numbers “192” are input into the second input field 52 as shown in FIG. 5A. Since the symbol “,” is a character other than the acceptable characters assigned to the second input field 52 (see FIG. 3), the second input field 52 shakes for a period (first period) of time as indicated by solid arrows in FIG. 5B.

Next, as shown in FIG. 5C, the second input field 52 stops shaking and a message, which indicates that the character input for the second input field 52 is not valid, is displayed for a period (second period) of time. The message reads, for example, “‘,’ is not acceptable in this field.”

Then, the second input field 52 changes from the state in which the message is displayed as shown in FIG. 5C to the state in which the numbers “192” and the cursor 41 are displayed as shown in FIG. 5A.

The embodiment which has been described provides the following advantages.

(1) In the printing device 20, if a character input for an input field 50 displayed by the display section 23 is a character other than the acceptable characters assigned to the input field 50 (i.e., if the character is a prohibited character), the input field 50 shakes. That is, if a user inputs an invalid character for the input field 50 displayed by the display section 23 through the operation section 21, the user is notified that the input character is not valid.

(2) When a character not acceptable in an input field 50 (i.e., a prohibited character) is input for the input field 50, a message, which notifies the user that an invalid character has been input, is displayed in the input field 50. This eliminates the necessity of providing an area only for the message and thus makes it possible to make good use of the limited space of the display section 23.

(3) If the message that notifies the user that an invalid character has been input is displayed in the input field 50 during the shaking of the input field 50, it is difficult for the user to see the message. In this respect, the present embodiment causes the message to be displayed after the shaking of the input field 50 has ended. This makes it easier for the user to see the message.

(4) The present embodiment assigns different acceptable characters to each input field 50. Therefore, even in the case where there exists a plurality of input fields 50 assigned different acceptable characters and where some of the characters that can be input through the operation section 21 are valid for one input field 50 but not valid for another input field 50, such characters are validated appropriately in each of the input fields 50.

(5) Image data read by the reading section 22 can be sent to the information terminal 30 on the network NW. Furthermore, if a user inputs an invalid character while inputting information about the information terminal 30 (the destination to which the image data is to be sent) into the input field 50 through the operation section 21, the user is notified that the input character is not valid.

The above embodiment may be modified in the following manner.

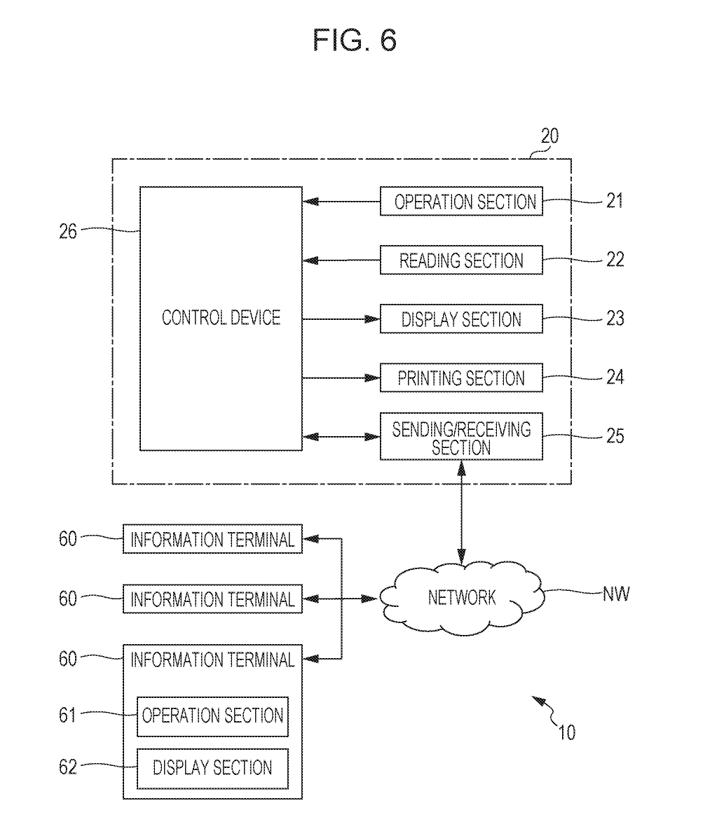

As shown in FIG. 6, an information terminal 60 on the network NW may include: an operation section 61 which allows input of letters, numbers, symbols, and the like; and a display section 62 which displays various kinds of information about the printing device 20. For example, in the case where the information terminal 60 is a personal computer, the operation section 61 is a keyboard and the display section 62 is a liquid crystal display.

In the above modification, the settings screen 40 shown in FIG. 2 may be displayed by the display section 62 of the information terminal 60 shown in FIG. 6 and characters may be input into the input fields 50 of the settings screen 40 through the operation section 61 of the information terminal 60. In this case, as with the earlier-described embodiment, the control device 26 may be configured to receive a character input for an input field 50 and determine whether or not the character is acceptable in the input field 50 displayed by the display section 62.

This arrangement provides the advantages (1) to (4) of the earlier-described embodiment. In addition, even in the case where a user makes various settings or the like on the printing device 20 through an information terminal 60 over the network NW at a distance from the printing device 20, the user is notified when the user inputs an invalid character for the input field 50 displayed by the display section 62 of the information terminal 60.

In the modified embodiment shown in FIG. 6, the operation section 21 and the display section 23 of the printing device 20 may be omitted.

The control device that causes an input field 50 of the display section 23 to shake in response to an invalid character input for the input field 50 may be included in an information terminal 30. In such a case, the control device is, for example, a printer driver.

In the description of the above embodiments, the settings screen displayed by the display section 23 is a screen for the settings of the reading section 22. Note, however, that the embodiments are also applicable to any other settings screen which is for the settings of some other functional section and which has the input fields 50. Examples of such other settings screen include: a settings screen for a connection between the printing device 20 and the network NW; and a settings screen for input of an e-mail address that is used to send scanned image data with an e-mail.

The following arrangement may also be employed. In the case where numbers are acceptable in an input field 50 but the allowed number range in this input field 50 is “0 (zero) to 255”, input of a number smaller than “0 (zero)” or a number larger than “255” is determined as input of an invalid character.

The reading section 22 may be omitted. The image data sending function of the sending/receiving section 25 may be omitted.

The character string that appears when an invalid character is input for an input field 50 (the character string indicating that an invalid character has been input for the input field 50) may be omitted.

The settings screen 40 on the display section 23 only needs to have at least one input field 50.

The input field in the settings screen 40 of the display section 23 does not have to be a “field”, provided that the settings screen 40 has an input area into which characters can be input.

This application claims priority under 35 U.S.C. §119 to Japanese Patent Application No. 2015-013032, filed Jan. 27 2015. The entire disclosure of Japanese Patent Application No. 2015-013032 is hereby incorporated herein by reference.

What is claimed is:

1. A control device for a printing device, the printing device including: a printing section configured to perform printing based on print data; and a receiving section configured to receive the print data over a network, the control device being configured to receive a character input for an input area displayed by a display section and, if the character does not comply with a validation rule applied to the input area, cause the input area to shake in the display section.

2. The control device according to claim 1, which is configured to, if the character input for the input area does not comply with the validation rule, display, in the input area, a character string indicating that the character does not comply with the validation rule.

3. The control device according to claim 2, which is configured to, if the character input for the input area does not comply with the validation rule, cause the input area to shake in the display section and thereafter display the character string in the input area.

4. The control device according to claim 1, which is configured to:
cause the display section to display a plurality of the input areas; and
apply respective validation rules to the plurality of input areas.

5. The control device according to claim 1, which is configured to receive the character input for the input area displayed by the display section which is included in an information terminal on the network.

6. A printing device comprising:
the control device according to claim 1;
a printing section configured to perform printing based on print data; and
a receiving section configured to receive the print data over a network.

7. A printing device comprising:
the control device according to claim 2;
a printing section configured to perform printing based on print data; and
a receiving section configured to receive the print data over a network.

8. A printing device comprising:
the control device according to claim 3;
a printing section configured to perform printing based on print data; and
a receiving section configured to receive the print data over a network.

9. A printing device comprising:
the control device according to claim 4;
a printing section configured to perform printing based on print data; and
a receiving section configured to receive the print data over a network.

10. A printing device comprising:
the control device according to claim 5;
a printing section configured to perform printing based on print data; and
a receiving section configured to receive the print data over a network.

11. The printing device according to claim 6, further comprising:
a reading section configured to read an image; and
a sending section configured to send, to an information terminal on the network, image data read by the reading section.

12. The printing device according to claim 7, further comprising:
a reading section configured to read an image; and
a sending section configured to send, to an information terminal on the network, image data read by the reading section.

13. The printing device according to claim 8, further comprising:
a reading section configured to read an image; and
a sending section configured to send, to an information terminal on the network, image data read by the reading section.

14. The printing device according to claim 9, further comprising:
a reading section configured to read an image; and
a sending section configured to send, to an information terminal on the network, image data read by the reading section.

15. The printing device according to claim 10, further comprising:
a reading section configured to read an image; and
a sending section configured to send, to an information terminal on the network, image data read by the reading section.
